(19) United States
(12) Patent Application Publication
(10) Pub. No.: US 2024/0389547 A1
(43) Pub. Date: Nov. 28, 2024

(54) Foldable Pet Fence

(71) Applicant: XIAMEN SUNNYPET PRODUCTS CO.,LTD, Xiamen (CN)

(72) Inventor: Kongzhi LU, Xiamen (CN)

(73) Assignee: XIAMEN SUNNYPET PRODUCTS CO.,LTD, Xiamen (CN)

(21) Appl. No.: 18/373,972

(22) Filed: Sep. 28, 2023

(30) Foreign Application Priority Data
May 26, 2023 (CN) 202321312332.4

(51) Int. Cl. A01K 1/035

(52) U.S. Cl. CPC A01K 1/035

(57) ABSTRACT

A foldable pet fence is provided, including a frame composed of a plurality of foldable supports hinged in sequence and a fabric supported on the frame. The fabric includes a main body, a plurality of upper connecting members, and a plurality of lower connecting members, and the plurality of upper connecting members and the plurality of lower connecting members are configured to detachably connect the fabric to the frame. The main body includes a deformable segment and a non-deformable segment, the non-deformable segment includes n pieces of non-deformable cloth, n is a positive integer, preferably an even number greater than or equal to 2, and the n pieces of non-deformable cloth are arranged in pairs opposite to each other.

### CROSS REFERENCE TO THE RELATED APPLICATIONS

This application is based upon and claims priority to Chinese Patent Application No. 202321312332.4, filed on May 26, 2023, the entire contents of which are incorporated herein by reference.

### TECHNICAL FIELD

The present disclosure relates to the technical field of pet supplies, and more specifically, refers to a foldable pet fence.

### BACKGROUND

As people's lifestyle changes, pets have become an important member of many families. As a result, the demand for pet supplies is continuously increasing. Pet fences, as one of pet supplies, are becoming more and more popular because they can provide activity space for pets while not interfering with anyone or anything else around. For the ease of carrying and storage, the existing pet fences are usually fabricated to have a foldable structure that includes a foldable frame, a soft fabric with one end fixed on the frame, and a cloth strip for fastening the fabric to the frame by tying the other end of the soft fabric to the frame. However, pet fences with this structure have the following drawbacks:
1. Since the fabric has one end fixed on the frame, when only the frame or only the fabric is broken and needed to repair, the whole pet fence has to be replaced with a new one and it is impossible to replace the damaged part only, thereby increasing use and maintenance costs.
2. The pet fence requires an additional cloth strip to secure the fabric to the frame during use, which results in cumbersome operation and complicates the structure.

In view of the above, there is an urgent need to develop a foldable pet fence that has simple structure, is easily implemented during use, and is convenient for repair and maintenance.

### SUMMARY

To address the deficiencies in the prior art, the present disclosure provides a foldable pet fence that is characterized by involving simple structure, convenient operation, easy replacement of parts and components, and low use and maintenance costs.

The present disclosure is implemented as follows:

A foldable pet fence includes a frame and a fabric supported on the frame. The fabric is composed of a plurality of foldable supports hinged in sequence. The fabric includes a main body, a plurality of upper connecting members, and a plurality of lower connecting members. The plurality of upper connecting members and the plurality of lower connecting members are configured to detachably connect the fabric to the frame.

Further, the main body includes a deformable segment and a non-deformable segment. The non-deformable segment includes n pieces of non-deformable cloth, n may be a positive integer. There is no limit as to the minimum number of non-deformable clothes.

Preferably, n may be an even number greater than or equal to 2, and the n pieces of non-deformable cloth are arranged in pairs opposite to each other.

Further, each of the plurality of foldable supports can be any shape, for example, X-shaped foldable supports.

Further, the fabric can be supported on an inner side or an outer side of the frame.

Further, the plurality of upper connecting members is configured to detachably connect the main body to an upper hinge joint of adjacent X-shaped foldable supports, and the plurality of lower connecting members is configured to detachably connect the main body to a lower hinge joint of adjacent X-shaped foldable supports. Alternatively, the plurality of upper connecting members is configured to detachably connect the main body to a lower hinge joint of adjacent X-shaped foldable supports, and the plurality of lower connecting members is configured to detachably connect the main body to an upper hinge joint of adjacent X-shaped foldable supports.

Further, the fabric further includes a plurality of middle connecting members configured to detachably connect the main body to an intersection of each of the X-shaped foldable supports.

Further, the main body is also provided with an entrance and exit port.

Further, each of the X-shaped foldable supports includes a first rod and a second rod intersected to form an X-shaped configuration, and each of the first rod and the second rod includes an upper end and a lower end.

Further, the upper end of the first rod of a first X-shaped foldable support is connected to the upper end of the second rod of a second X-shaped foldable support through a first upper hinge member, and the upper end of the second rod of the first X-shaped foldable support is connected to the upper end of the first rod of a third X-shaped foldable support through a second upper hinge member. Both the second X-shaped foldable support and the third X-shaped foldable support are adjacent to the first X-shaped foldable support. The lower end of the first rod of the first X-shaped foldable support is connected to the lower end of the second rod of the third X-shaped foldable support through a first lower hinge member, and the lower end of the second rod of the first X-shaped foldable support is connected to the lower end of the first rod of the second adjacent X-shaped foldable support through a second lower hinge member.

Further, each of the first upper hinge member, the second upper hinge member, the first lower hinge member, and the second lower hinge member includes a first hinge rod, a second hinge rod, and a hinge pin shaft. The first hinge rod is provided with a slot, the second hinge rod is provided with an insertion block, and the insertion block is configured to be inserted into the slot. The side of the slot is provided with a through hole, and the side of the insertion block is provided with a through hole, when the insertion block is inserted into the slot, the through hole of the slot and the through hole of the insertion block completely overlap each other to allow the hinge pin shaft to be inserted therein, so that the first hinge rod and the second hinge rod are rotatably connected.

Further, the plurality of upper connecting members includes first upper connecting members and second upper connecting members, and the plurality of lower connecting members includes first lower connecting members and second lower connecting members. The first upper connecting members and the first lower connecting members are fixed on the non-deformable segment, and the second upper connecting members and the second lower connecting members are fixed on the deformable segment.

Further, each of the first upper connecting members includes a first non-deformable cloth strip, a second non-deformable cloth strip, a buckle, and a fixing element. The first non-deformable cloth strip is configured to secure the buckle at the upper end of the main body, the second non-deformable cloth strip includes a fixed end integrally formed at the upper end of the main body and a free end detachably connected to the non-deformable segment, and the fixing element is fixedly provided on the non-deformable segment.

Further, each of the second upper connecting members includes a third non-deformable cloth strip and a fourth non-deformable cloth strip. The third non-deformable cloth strip includes a fixed end integrally formed at the upper end of the main body and a free end. The fourth non-deformable cloth strip includes a fixed end integrally formed at the upper end of the main body and a free end. The free end of the third non-deformable cloth strip and the free end of the fourth non-deformable cloth strip is detachably connected.

Further, each of the plurality of lower connecting members is fixedly formed at the lower end of the main body, and each of the first lower connecting members and second lower connecting members is a non-deformable cloth pocket for receiving a hinge joint of lower ends of adjacent X-shaped foldable supports.

Further, the number of the first upper connecting members is equal to the number of the non-deformable cloth, the number of the first lower connecting members is equal to the number of the non-deformable cloth, and the total number of the first lower connecting members and the second lower connecting members is equal to the number of the X-shaped foldable supports.

Further, the non-deformable cloth is oxford cloth, and the deformable segment is made of mesh cloth.

Preferably, the number of the X-shaped foldable supports is four or six.

Another foldable pet fence is provided, including a frame and a fabric supported on the frame. The frame includes a plurality of foldable supports hinged in sequence. The fabric includes at least one non-deformable segment and a plurality of connecting members for detachably securing the fabric to the frame.

Further, the non-deformable segment includes n pieces of non-deformable cloth, and n is a positive integer, preferably an even number greater than or equal to 2, and the n pieces of non-deformable cloth are arranged in pairs opposite to each other.

Further, each of the plurality of foldable supports can be any shape, for example, X-shaped foldable supports.

Further, the fabric can be supported on an inner side or an outer side of the frame.

Further, each of the plurality of connecting members is made of a non-deformable material, such as oxford cloth that has low elasticity, light texture, and soft touch. At least one connecting member is arranged on the non-deformable segment. The cooperation of the non-deformable segment and the non-deformable connecting member allows the pet fence to be unfolded and fixed by itself without the need of additional securing element and improves the stability of the pet fence during use since no deformation will occur at the connecting portion.

Compared with the prior art, the present disclosure has the following advantages:
1. The foldable pet fence provided by the present disclosure includes a fabric that inherently has a non-deformable segment and non-deformable connecting members. The non-deformable segment and the non-deformable connecting members can cooperate to fix the frame of the pet fence and firmly secure the fabric to the frame without deformation. That is, the fabric itself can achieve the positioning and adhesion of the fabric to the frame without the need of using any additional securing element (e.g. additional cloth strip mentioned in the prior art), thereby simplifying the structure of the pet fence and facilitating the operation during use.
2. Since the upper connecting members, the middle connecting members, and the lower connecting members of the fabric are all configured in a detachable connection to the frame, the frame and the fabric can be completely separated. As a result, the fabric is easily removed for cleaning. Furthermore, if the frame or the fabric is broken, the two can be separated to repair or replace the broken part, thereby reducing use and maintenance costs.

### BRIEF DESCRIPTION OF THE DRAWINGS

FIG. 1 is a perspective view showing the structure of the foldable pet fence according to Embodiment 1 of the present disclosure.

FIG. 2 is a structural diagram of the X-shaped foldable support.

FIG. 3 is a perspective view showing the structure of the frame.

FIG. 4 is a structural diagram of the hinge member in a hinged state.

FIG. 5 is a cross-sectional view taken from line A-A of FIG. 4.

FIG. 6 is a partially enlarged view showing the first upper connecting member.

FIG. 7 is a partially enlarged view showing the second upper connecting member.

FIG. 8 is a schematic diagram showing the folding process of the pet fence.

FIG. 9 is a perspective view showing the structure of the foldable pet fence according to Embodiment 2 of the present disclosure.

FIG. 10 is a perspective view showing the structure of the foldable pet fence according to Embodiment 3 of the present disclosure.

FIG. 11 is a perspective view showing the structure of the foldable pet fence according to Embodiment 4 of the present disclosure.

FIG. 12 is a picture showing the structure of the foldable pet fence according to Embodiment 5 of the present disclosure.

In the figures:

1. frame, 10. X-shaped foldable support, 101. first rod, 101a. upper end, 101b. lower end, 102. second rod, 102a. upper end, 102b. lower end, 2. fabric, 21. deformable segment, 22. non-deformable segment, 23. upper connecting member, 231. first upper connecting member, 2311. first non-deformable cloth strip, 2312. second non-deformable cloth strip, 2312a. fixed end, 2312b. free end, 2313. buckle, 2314. fixing element, 232. second upper connecting member, 2321. third non-deformable cloth strip, 2321a. fixed end, 2321b. free end, 2322. fourth non-deformable cloth strip, 2322a. fixed end, 2322b. free end, 24. lower connecting member, 241. first lower connecting member, 242. second lower connecting member, 25. entrance and exit port, 26. middle connecting member, 3. upper hinge member, 31. first hinge rod, 311. slot, 311a. through hole, 32. second hinge rod, 321. insertion block, 321a. through hole, 33. hinge pin shaft, 4. lower hinge member.

### DETAILED DESCRIPTION OF THE EMBODIMENTS

The specific embodiments of the present disclosure is explained below with reference to the accompanying drawings.

### Embodiment 1

The present embodiment provides a foldable pet fence, including the frame 1 and the fabric 2 supported on the frame 1. The frame 1 is composed of a plurality of foldable supports 10 hinged in sequence. The fabric 2 includes a main body, a plurality of upper connecting members 23, and a plurality of lower connecting members 24. The plurality of upper connecting members 23 and the plurality of lower connecting members 24 are configured to detachably connect the fabric 2 to the frame 1.

In the present embodiment, each of the plurality of foldable supports can be any shape, for example, X-shaped foldable supports.

In the present embodiment, the fabric can be supported on an inner side or an outer side of the frame.

### Embodiment 2

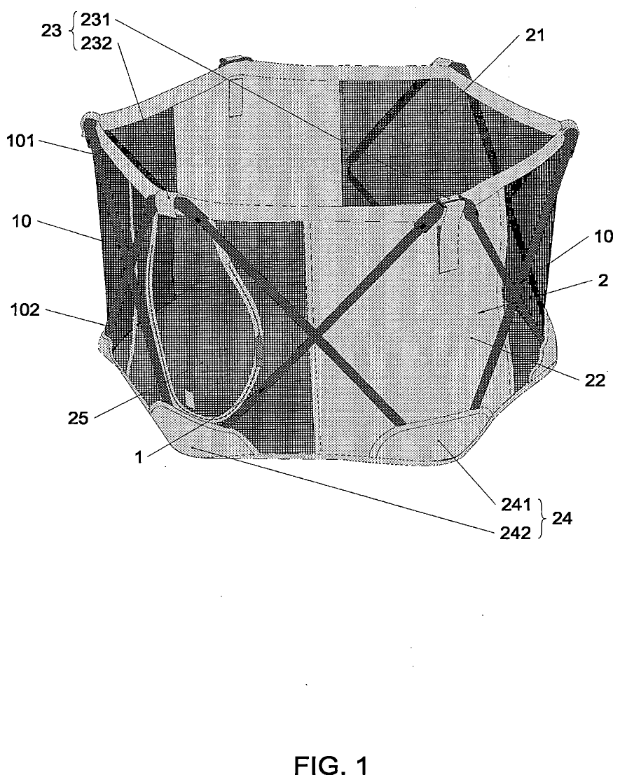

A foldable pet fence, as shown in FIG. 1, includes the frame 1 and the fabric 2 supported on the inner side of the frame 1. The frame 1 is composed of a plurality of X-shaped foldable supports 10 hinged in sequence. The fabric 2 includes a main body, a plurality of upper connecting members 23, and a plurality of lower connecting members 24. The plurality of upper connecting members 23 and the plurality of lower connecting members 24 are configured to detachably connect the fabric 2 to the frame 1. The main body includes the deformable segment 21 and the non-deformable segment 22. The non-deformable segment 22 includes n pieces of non-deformable cloth, n is a positive integer, and the n pieces of non-deformable cloth are arranged in pairs opposite to each other.

In the present embodiment, the frame 1 is composed of six X-shaped foldable supports 10 that are sequentially hinged. The non-deformable segment 22 includes two pieces of non-deformable cloth arranged in pairs opposite to each other.

The main body of the fabric 2 is further provided with the entrance and exit port 25 to allow a pet to go into and out of the pet fence therethrough. The entrance and exit port 25 can be provided on either the deformable segment 21 or the non-deformable segment 22. The entrance and exit port 25 can be exposed by partially removing a piece of cloth from the main body and and can be covered by totally connecting the piece of cloth to the main body through a zipper, a button, or any similar element.

The plurality of upper connecting members 23 is configured to detachably connect the main body of the fabric 2 to an upper hinge joint of adjacent X-shaped foldable supports 10, and the plurality of lower connecting members 24 is configured to detachably connect the main body of the fabric 2 to a lower hinge joint of adjacent X-shaped foldable supports 10. The use of the upper and lower connecting members inherently carried by the fabric itself allows the omission of additional cloth trip for securing the fabric to the frame, thus simplifying the structure.

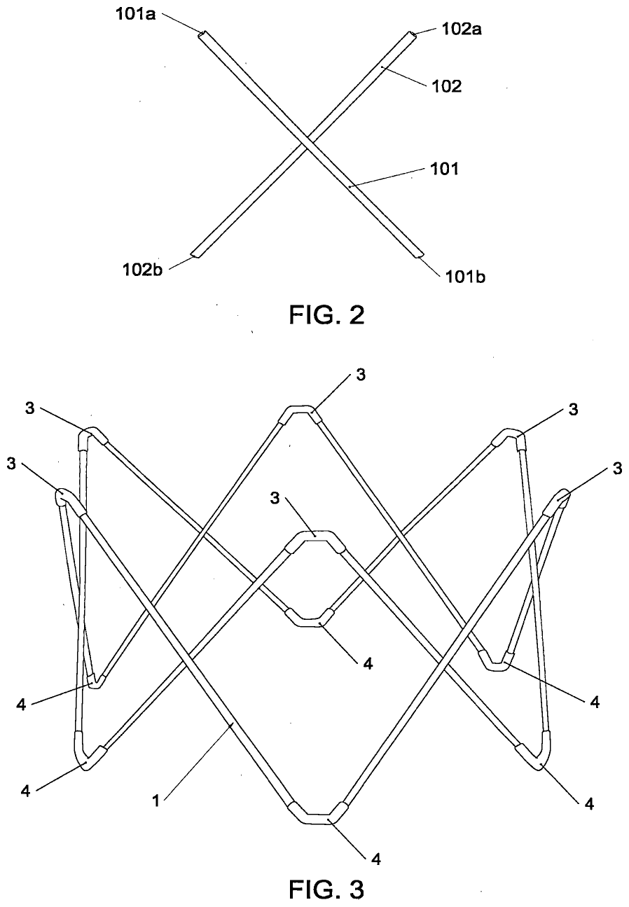

As shown in FIG. 2 and FIG. 3, each of the X-shaped foldable supports 10 includes the first rod 101 and the second rod 102 intersected to form an X-shaped configuration. The first rod 101 includes the upper end 101a and the lower end 101b, and the second rod 102 includes the upper end 102a and the lower end 102b. The upper end 101a of the first rod 101 of the first X-shaped foldable support 10 of the six X-shaped foldable supports is connected to the upper end 102a of the second rod 102 of the second X-shaped foldable support 10 of the six X-shaped foldable supports through the upper hinge member 3, and the upper end 102a of the second rod 102 of the first X-shaped foldable support 10 is connected to the upper end 101a of the first rod 101 of the third X-shaped foldable support 10 of the six X-shaped foldable supports through another upper hinge member 3. Both the second X-shaped foldable support and the third X-shaped foldable support are adjacent to the first X-shaped foldable support. The lower end 101b of the first rod 101 of the first X-shaped foldable support 10 is connected to the lower end 102b of the second rod 102 of the third X-shaped foldable support 10 through the lower hinge member 4, and the lower end 102b of the second rod 102 of the first X-shaped foldable support 10 is connected to the lower end 101b of the first rod 101 of the second adjacent X-shaped foldable support 10 through another lower hinge member 4.

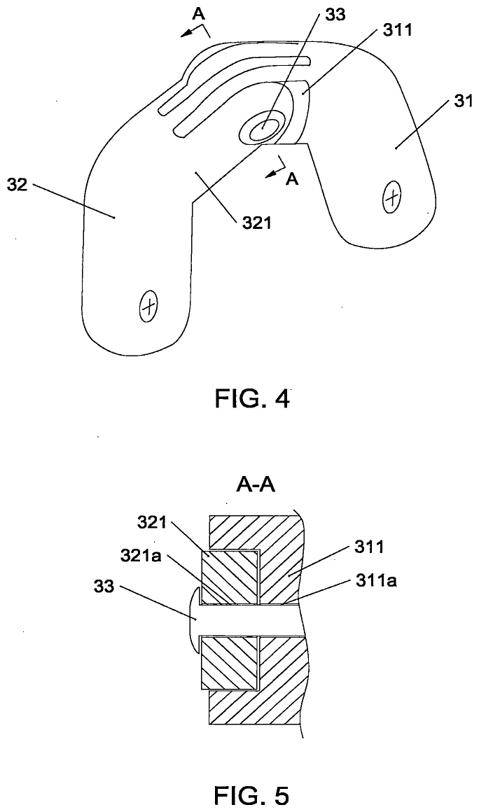

The upper hinge member 3 and the lower hinge member 4 can have the same or different structure as long as they can hinge the six X-shaped foldable supports 10 together in sequence. In the present embodiment, the upper hinge member 3 and the lower hinge member 4 have the same structure, as shown in FIG. 4.

Taking the upper hinge member 3 as an example, referring to FIG. 4 and FIG. 5, the upper hinge member 3 specifically includes the first hinge rod 31, the second hinge rod 32, and the hinge pin shaft 33. The first hinge rod 31 is provided with the slot 311, and the second hinge rod 32 is provided with the insertion block 321 that can be inserted into the slot 311. The side of the slot 311 is provided with the through hole 311a in a penetrating manner, and the side of the insertion block 321 is provided with the through hole 321a in a penetrating manner. When the insertion block 321 is inserted into the slot 311, the through hole 311a and the through hole 321a completely overlap each other to allow the hinge pin shaft 33 to be inserted therein, so that the first hinge rod 31 and the second hinge rod 32 are rotatably connected.

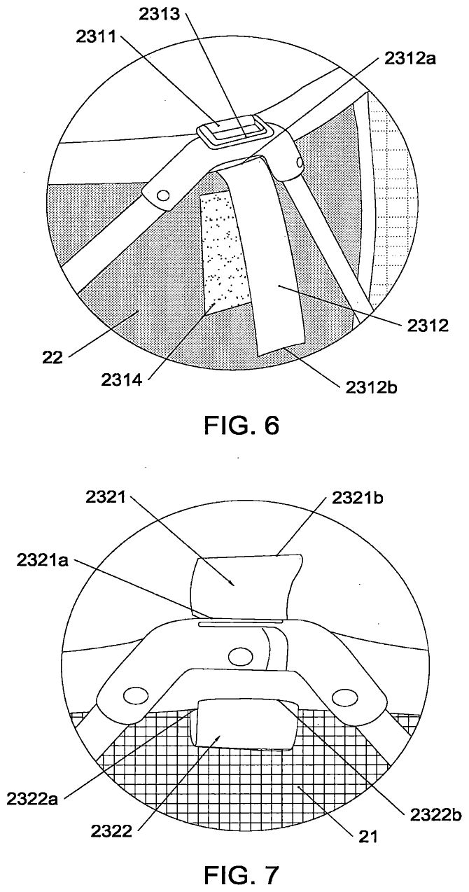

The plurality of upper connecting members 23 includes first upper connecting members 231 and second upper connecting members 232, and the plurality of lower connecting members 24 includes first lower connecting members 241 and second lower connecting members 242. The first upper connecting members 231 and the first lower connecting members 241 are fixed on the non-deformable segment 22, and the second upper connecting members 232 and the second lower connecting members 242 are fixed on the deformable segment 21. As show in FIG. 6, the first upper connecting member 231 includes the first non-deformable cloth strip 2311, the second non-deformable cloth strip 2312, the buckle 2313, and the fixing element 2314. The first non-deformable cloth strip 2311 is configured to secure the buckle 2313 at the upper end of the main body, the second non-deformable cloth strip 2312 includes the fixed end 2312a integrally formed at the upper end of the main body and the free end 2312b detachably connected to the non-deformable segment 22, and the fixing element 2314 is fixedly provided on the non-deformable segment 22. The fixing element 2314 can any structure as long as it can fix the second non-deformable cloth strip 2312 to the non-deformable segment 22, for example, a hook and loop fastener.

During the process of unfolding the fabric 2, the free end 2312b of the second non-deformable cloth strip 2312 is pulled by a user to wrap around a hinge joint of upper ends of adjacent X-shaped foldable supports 10, pass through the buckle 2313, and move downwards to allow the main body to be completely unfolded in a longitudinal direction and fixed to the frame 1 after the free end 2312b is connected to the non-deformable segment 22 by the fixing element 2314. Since the the design of the non-deformable segment 22 and the first upper connecting member 231 including non-deformable cloth strips, they can cooperate to fixing the unfolded fabric and frame without deformation, thereby enhancing use stability.

As shown in FIG. 7, the second upper connecting member 232 includes the third non-deformable cloth strip 2321 and the fourth non-deformable cloth strip 2322. The third non-deformable cloth strip 2321 has the fixed end 2321a integrally formed at the upper end of the main body and the free end 2321b. The fourth non-deformable cloth strip 2322 has the fixed end 2322a integrally formed at the upper end of the main body and the free end 2322b. The free end 2321b and the free end 2322b can be detachably connected to allow a hinge joint of upper ends of adjacent X-shaped foldable supports 10 to be fastened by or released from the second upper connecting member 232.

Each of the plurality of lower connecting members 24 is fixedly formed at the lower end of the main body, and each of the first lower connecting members 241 and second lower connecting members 242 is a non-deformable cloth pocket for receiving a hinge joint of lower ends of adjacent X-shaped foldable supports 10. The pocket design provides an all-round enclosure for the hinge joint, increases the supporting area at the bottom, and improve the base stability during use.

The number of the first upper connecting members 231 is equal to the number of the non-deformable cloth, the number of the first lower connecting members 241 is equal to the number of the non-deformable cloth, and a total number of the first lower connecting members 241 and the second lower connecting members 242 is equal to the number of the X-shaped foldable supports 10.

The non-deformable cloth can be any material as long as it does not deform when being pulled, for example, oxford cloth that has low elasticity, light texture, and soft touch. The use of non-deformable material ensures the fabric 2 to be reliably secured to the frame 1 without the need of using any additional securing element, thus simplifying the structure of the pet fence, facilitating the operation during use, reducing parts and components, and saving cost. The material of the deformable segment can be selected according to actual needs, for example, mesh cloth that allows observation of a pet inside and promotes air circulation inside and outside the pet fence.

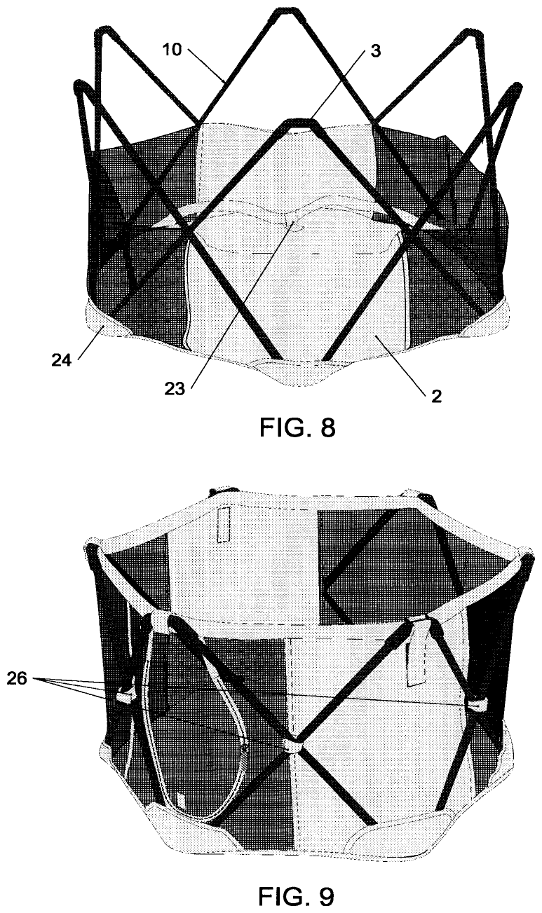

Referring to FIG. 8, during the folding process of the pet fence, each of the plurality of upper connecting member 23 is unlocked to release the upper hinge member 3, so that the fabric 2 can be folded towards the inner space of the pet fence. Subsequently, each X-shaped foldable support 10 is pushed towards the center to reach a folded state for storage. The lower hinge member 4 can be maintained inside or removed from the corresponding lower connecting member 24 as needed. For instance, when the fabric 2 needs cleaning or any of the frame 1 and fabric 2 needs replacement, the lower hinge member 4 can be removed from the corresponding lower connecting member 24; when the pet fence only needs to be stored to save space, the lower hinge member 4 can be maintained inside the corresponding lower connecting member 24 for the convenience of next use. During the unfolding process of the pet fence, each X-shaped foldable support 10 is pulled out, each upper connecting member 23 is lifted and connected to the upper hinge member 3, and optionally, each lower hinge member 4 is put into the corresponding lower connecting member 24, so that the pet fence reaches a unfolded state.

### Embodiment 3

The present embodiment is basically the same as Embodiment 2 except that the fabric 2 further includes a plurality of middle connecting members 26 configured to detachably connect the main body to an intersection of each of the X-shaped foldable supports 10, as shown in FIG. 9. The addition of the middle connecting members 26 further improves the reliability of securing the main body to the frame 1 during use.

### Embodiment 4

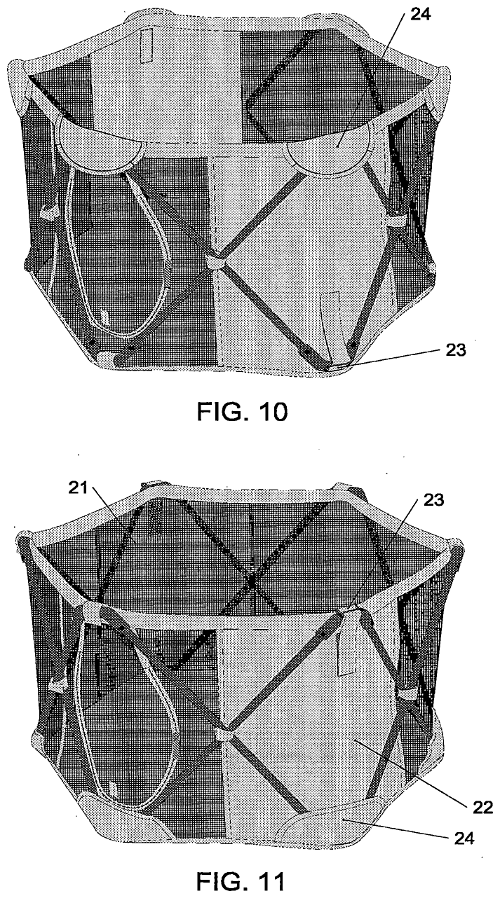

On the basis of any of Embodiments 2-3 above, the present embodiment exchanges the positions where the upper connecting members 23 and the lower connecting members 24 are provided, as shown in FIG. 10. The the upper connecting members 23 are arranged at the lower end of the main body, and the lower connecting members 24 are arranged at the upper end of the main body.

### Embodiment 5

On the basis of any of Embodiments 2-4 above, the present embodiment reduces the number of non-deformable cloth, as shown in FIG. 11, only one non-deformable cloth is used.

### Embodiment 6

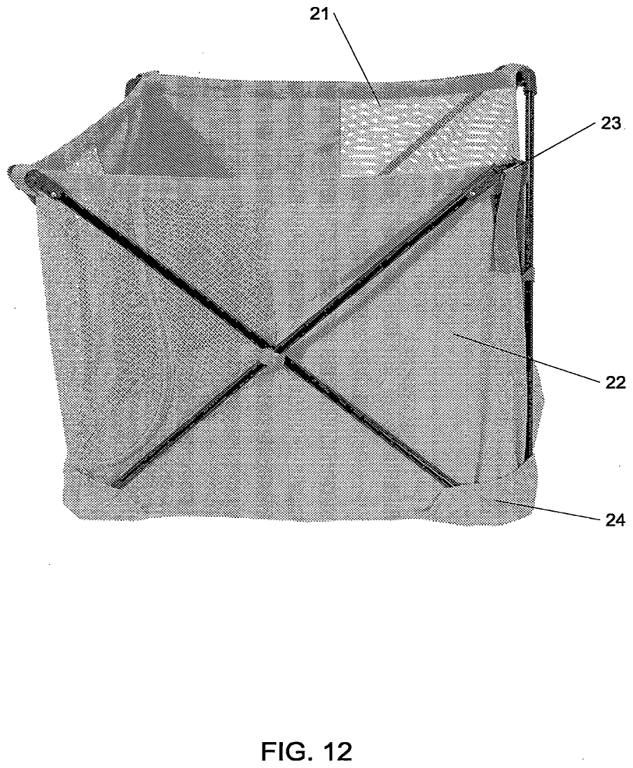

On the basis of any of Embodiments 2-5 above, in the present embodiment, four X-shaped foldable supports 10 are used to replace the previous six X-shaped foldable supports 10 to form the frame 1 in a rectangular configuration, as shown in FIG. 12.

### Embodiment 7

On the basis of any of Embodiments 2-6 above, in the present embodiment, the non-deformable segment 22 is eliminated, instead, the fabric is totally made of a deformable material.

### Embodiment 8

On the basis of any of Embodiments 2-6 above, in the present embodiment, the deformable segment 21 is eliminated, instead, the fabric is totally made of a non-deformable material.

### Embodiment 9

The present embodiment provides a foldable pet fence, including the frame 1 and the fabric 2 supported on the frame 1. The frame 1 includes a plurality of foldable supports 10 hinged in sequence. The fabric 2 includes at least one non-deformable segment 22 and a plurality of connecting members 23/24 for detachably securing the fabric 2 to the frame 1.

The non-deformable segment 22 includes n pieces of non-deformable cloth, and n is a positive integer, preferably an even number greater than or equal to 2, and the n pieces of non-deformable cloth are arranged in pairs opposite to each other.

In the present embodiment, each of the plurality of foldable supports can be any shape, for example, X-shaped foldable supports.

In the present embodiment, the fabric can be supported on an inner side or an outer side of the frame.

Each of the plurality of connecting members is made of a non-deformable material, such as oxford cloth that has low elasticity, light texture, and soft touch. At least one connecting member is arranged on the non-deformable segment 22. The cooperation of the non-deformable segment 22 and the non-deformable connecting member allows the pet fence to be unfolded and fixed by itself without the need of additional securing element and improves the stability of the pet fence during use since no deformation will occur at the connecting portion.

It should be noted that in the same pet fence, the arrangement of the upper connecting members and the lower connecting members is not limited to a single embodiment. Any combination of these embodiments, as long as the fabric 2 can be secured to the frame 1, is allowed.

The above are only the specific embodiments of the present disclosure, but the technical concept of the present disclosure is not limited thereto. Any non substantive modifications made to the present disclosure based on the technical concept of the present disclosure should be considered as falling within the scope of protection of the present disclosure.

What is claimed is:

1. A foldable pet fence, comprising:
a frame comprising a plurality of foldable supports hinged in sequence, and
a fabric supported on the frame;
wherein
the fabric comprises a main body, a plurality of upper connecting members, and a plurality of lower connecting members, and the plurality of upper connecting members and the plurality of lower connecting members are configured to detachably connect the fabric to the frame.

2. The foldable pet fence according to claim 1, wherein the main body comprises a deformable segment and a non-deformable segment, the non-deformable segment comprises n pieces of non-deformable cloth, and n is a positive integer.

3. The foldable pet fence according to claim 1, wherein the fabric is supported on an inner side of the frame.

4. The foldable pet fence according to claim 1, wherein the plurality of foldable supports are a plurality of X-shaped foldable supports, the plurality of upper connecting members is configured to detachably connect the main body to an upper hinge joint of adjacent X-shaped foldable supports, and the plurality of lower connecting members is configured to detachably connect the main body to a lower hinge joint of adjacent X-shaped foldable supports.

5. The foldable pet fence according to claim 4, wherein the fabric further comprises a plurality of middle connecting members configured to detachably connect the main body to an intersection of each of the X-shaped foldable supports.

6. The foldable pet fence according to claim 1, wherein
the plurality of foldable supports are a plurality of X-shaped foldable supports;
each of the X-shaped foldable supports comprises a first rod and a second rod intersected to form an X-shaped configuration, each of the first rod and the second rod comprises an upper end and a lower end;
the upper end of the first rod of a first X-shaped foldable support of the plurality of X-shaped foldable supports is connected to the upper end of the second rod of a second X-shaped foldable support of the plurality of X-shaped foldable supports through a first upper hinge member, and the upper end of the second rod of the first X-shaped foldable support is connected to the upper end of the first rod of a third X-shaped foldable support of the plurality of X-shaped foldable supports through a second upper hinge member, both the second X-shaped foldable support and the third X-shaped foldable support are adjacent to the first X-shaped foldable support;
the lower end of the first rod of the first X-shaped foldable support is connected to the lower end of the second rod of the third X-shaped foldable support through a first lower hinge member, and the lower end of the second rod of the first X-shaped foldable support is connected to the lower end of the first rod of the second adjacent X-shaped foldable support through a second lower hinge member.

7. The foldable pet fence according to claim 6, wherein
each of the first upper hinge member, the second upper hinge member, the first lower hinge member, and the second lower hinge member comprises a first hinge rod, a second hinge rod, and a hinge pin shaft;
the first hinge rod is provided with a slot, the second hinge rod is provided with an insertion block, and the insertion block is configured to be inserted into the slot;
a side of the slot is provided with a through hole in a penetrating manner, and a side of the insertion block is provided with a through hole in a penetrating manner, when the insertion block is inserted into the slot, the through hole of the slot and the through hole of the insertion block completely overlap each other to allow the hinge pin shaft to be inserted therein, so that the first hinge rod and the second hinge rod are rotatably connected.

8. The foldable pet fence according to claim 2, wherein
the plurality of upper connecting members comprises first upper connecting members and second upper connecting members, and the plurality of lower connecting members comprises first lower connecting members and second lower connecting members;
the first upper connecting members and the first lower connecting members are fixed on the non-deformable segment, and the second upper connecting members and the second lower connecting members are fixed on the deformable segment.

9. The foldable pet fence according to claim 8, wherein
each of the first upper connecting members comprises a first non-deformable cloth strip, a second non-deformable cloth strip, a buckle, and a fixing element, the first non-deformable cloth strip is configured to secure the buckle at an upper end of the main body, the second non-deformable cloth strip comprises a fixed end integrally formed at the upper end of the main body and a free end detachably connected to the non-deformable segment, the fixing element is fixedly provided on the non-deformable segment.

10. The foldable pet fence according to claim 8, wherein
each of the second upper connecting members comprises a third non-deformable cloth strip and a fourth non-deformable cloth strip, the third non-deformable cloth strip comprises a fixed end integrally formed at an upper end of the main body and a free end, the fourth non-deformable cloth strip comprises a fixed end integrally formed at the upper end of the main body and a free end, the free end of the third non-deformable cloth strip and the free end of the fourth non-deformable cloth strip is detachably connected.

11. The foldable pet fence according to claim 8, wherein each of the plurality of lower connecting members is fixedly formed at a lower end of the main body, and each of the first lower connecting members and second lower connecting members is a non-deformable cloth pocket for receiving a hinge joint of lower ends of adjacent X-shaped foldable supports.

12. The foldable pet fence according to claim 8, wherein a number of the first upper connecting members is equal to a number of the non-deformable cloth, a number of the first lower connecting members is equal to the number of the non-deformable cloth, and a total number of the first lower connecting members and the second lower connecting members is equal to a number of the X-shaped foldable supports.

13. The foldable pet fence according to claim 1, wherein a number of the X-shaped foldable supports is four or six.

14. The foldable pet fence according to claim 1, wherein the plurality of foldable supports are a plurality of X-shaped foldable supports, the plurality of upper connecting members is configured to detachably connect the main body to a lower hinge joint of adjacent X-shaped foldable supports, and the plurality of lower connecting members is configured to detachably connect the main body to an upper hinge joint of adjacent X-shaped foldable supports.

15. A foldable pet fence, comprising:
a frame comprising a plurality of foldable supports hinged in sequence, and
a fabric supported on the frame;
wherein
the fabric comprises at least one non-deformable segment and a plurality of connecting members for detachably securing the fabric to the frame.

16. The foldable pet fence according to claim 15, wherein the plurality of foldable supports are a plurality of X-shaped foldable supports.

17. The foldable pet fence according to claim 15, wherein the fabric is supported on an inner side of the frame.

18. The foldable pet fence according to claim 15, wherein the non-deformable segment comprises n pieces of non-deformable cloth, and n is a positive integer.

19. The foldable pet fence according to claim 15, wherein each of the plurality of connecting members is made of a non-deformable material.

20. The foldable pet fence according to claim 19, wherein at least one of the plurality of connecting members is arranged on the non-deformable segment.
